(19) United States
(12) Patent Application Publication
(10) Pub. No.: US 2014/0058678 A1
(43) Pub. Date: Feb. 27, 2014

(54) True-Amplitude Layer-Stripping in Fractured Media

(71) Applicants: Reeshidev Bansal, Spring, TX (US); Michael P. Matheney, The Woodlands, TX (US); Enru Liu, Sugar Land, TX (US)

(72) Inventors: Reeshidev Bansal, Spring, TX (US); Michael P. Matheney, The Woodlands, TX (US); Enru Liu, Sugar Land, TX (US)

(21) Appl. No.: 14/110,581

(22) PCT Filed: Mar. 9, 2012
(86) PCT No.: PCT/US12/28545

§ 371 Date: Oct. 8, 2013

Related U.S. Application Data
(60) Provisional application No. 61/484,949, filed on May 11, 2011.

(51) Int. Cl. G01V 1/30

(52) U.S. Cl. CPC G01V 1/30
USPC 702/14

(57) ABSTRACT

Method for determining fracture orientation and fracture intensity in multiple fractured layers in the subsurface in a layer-stripping manner. Multi-component, multi-azimuth seismic data are required (31), from which the horizontal, primarily converted wave, components are selected, and these data are further reduced by selecting only the data for which the survey azimuths are either parallel or perpendicular to the general fracture strike (33). If the general fracture trend is unknown, such selective data may be determined by an azimuth-offset scanning process. Layer stripping is performed on azimuth/offset stacks (42) to produce fracture parameter maps (43). All offsets are stacked in those azimuths that produce consistent fracture parameter maps (44), then layer stripping is performed (45) on the stacks to produce final fracture orientation and S-wave time difference maps (46). These maps can be used to produce true amplitude fast and slow S-waves (56).

### CROSS-REFERENCE TO RELATED APPLICATION

This application claims the benefit of U.S. Provisional Patent Application 61/484,949, filed May 11, 2011, entitled TRUE-AMPLITUDE LAYER-STRIPPING IN FACTURED MEDIA, the entirety of which is incorporated by reference herein.

### FIELD OF INVENTION

This invention relates generally to the field of geophysical prospecting and, more particularly to seismic data processing. Specifically, the invention is a method for fracture characterization in the subsurface using seismic data. More specifically, the inventive method determines fracture orientation and fracture intensity in multiple fractured layers in the subsurface in a layer-stripping manner, and also produces true-amplitude layer-stripped geophysical seismic data which can be further used for general lithology prediction of the subsurface.

### BACKGROUND OF THE INVENTION

Usually, fracture networks, especially in tight-gas sands, are exploited for efficient hydrocarbon recovery from the reservoirs [1, 2]. Sometimes, hydrocarbon recovery completely relies on the exploitation of the natural fracture networks in the subsurface.

Several geophysical techniques are available for characterizing fracture networks in the subsurface and each has its own advantages and disadvantages. All these techniques can be divided into two broad categories: (1) direct measurements and (2) indirect (or remote) measurements. An example of a direct measurement is a well-bore based method. Usually a geophysical instrument is sent into the well-bore and the geophysical tool measures the subsurface properties such as seismic velocities. These subsurface data are used to predict the fracture properties of the subsurface [3]. Although these types of techniques are very reliable, they provide fracture properties only at the well bore location. Away from the well-bore, these methods cannot be trusted for fracture characterization.

An example of an indirect or remote measurement is surface seismic method. Surface seismic methods are one of the most common techniques for subsurface imaging. Seismic P- and S-waves are the two types of seismic waves that are used for this purpose. A P-wave source such as dynamite is used to excite P-wave energy which travels down the subsurface and reflects back both as P- and S-waves. These reflected waves are captured by surface receivers. These reflected energies are used to generate subsurface images and to derive other subsurface properties. P-waves are recorded by vertically oriented receivers and S-wave energies are recoded by horizontally oriented receivers. The reflected P-wave energies are traditionally called PP modes and the reflected S-wave energies are called PS or converted-wave modes.

In the past, geophysicists have proposed and implemented a number of techniques to characterize fractures using surface seismic data. Fractured reservoirs are known to behave as an azimuthally anisotropic medium on the scale of seismic wavelengths [4]. Ruger and Tsvankin [5] showed that PP-reflectivity in fractured reservoirs varies with the fracture azimuth. They also gave analytical expressions for PP-reflectivity which could be used to estimate fracture density (or intensity) of the medium. Methods based on this property of the PP-mode are called AVAZ-based methods.

S-waves travelling through a fractured medium split into fast (S₁) and slow (S₂) modes. The particle motions of S₁- and S₂-waves are polarized parallel and perpendicular to fracture strike, respectively. S-waves polarized parallel to fractures (S₁) have a greater velocity than the S-waves polarized perpendicular to fractures (S₂). The difference between the fast and slow S-wave velocities is directly proportional to fracture density; i.e. the larger the fracture density, the larger the difference between velocities. This phenomenon is called S-wave birefringence [6]. A number of fracture characterization methods have been proposed based on this property of S-wave.

Alford [7, 15] proposed a technique for a VSP geometry that includes rotating, in a synchronic way, source and receiver geophone by linearly combining the two polarizations. The method requires two orthogonal source components and two orthogonal receiver components. A 2×2 data matrix is formed and the energy in the off-diagonal terms are minimized by tensor rotation. The angle at which the off-diagonal energy is minimized is the azimuth of the fractures in the subsurface. The main disadvantage of this method is that the estimated fracture properties are only reliable at the VSP location.

Winterstein and Meadows [8] reported that the subsurface rarely has only one fractured layer; instead, many fractured layers with varying fracture orientations are more common. They proposed a coarse-layer stripping technique to deal with this problem. The following is the idea behind their method; first rotate and find the time difference between S₁ and S₂ for the arrivals from the bottom of the first fractured layer, then subtract the one- or two-way time (depending on whether the data is VSP or surface seismic) from the arrivals from the bottom of next fractured layer and correct for time lag by the first fractured layer. The procedure is repeated for subsequent fractured layers.

Gaiser [9, 14] extended the method of Alford [7, 15] to characterize subsurface fractures using surface seismic PS data. Unlike the method of Alford [7, 15], Gaiser's technique uses surface seismic data for fracture characterization. Gaiser's method can also perform coarse layer-stripping in the presence of multiple fractured layers.

All the previous fracture characterization methods make an inherent assumption that particle displacement of split S-waves propagating through a fractured medium are polarized parallel and perpendicular to the fractures strike. This assumption holds for vertically propagating S-waves. These limitations may lead to erroneous results, especially in more complicated fractured media (such as in Orthorhombic medium). Moreover, none of the above mentioned method produces pure PS₁ and PS₂ modes. These limitations seriously impact further usage of the PS data such as for subsurface lithology prediction.

A medium with a single set of aligned vertical fractures in an isotropic medium behaves like an Horizontal Transversally Isotropic (HTI) medium. This type of medium is azimuthally anisotropic in nature. Sometimes, fractured media are also addressed as an HTI medium. However, a more common type of fractured reservoir tends to be orthorhombic in nature. This type of anisotropy is constituted by one set of aligned vertical fractures in a Vertical Transversally Isotropic (VTI) background medium. It is well know that, regardless of fracturing, in most parts of the world the subsurface exhibit VTI anisotropy either due to intrinsic anisotropy or because of the presence of thin sand/shale sequences [10]. In summary, existing methods may be expected to have problems in complicated fractured media such as an orthorhombic medium.

### SUMMARY OF THE INVENTION

In one embodiment, the invention is a computer-implemented method for transforming seismic data into an estimate of fracture orientations and intensity, or of lithology, within a multi-fractured subsurface formation having a plurality of parallel fracture layers, comprising:

(a) obtaining seismic data acquired from the subsurface formation using multi-component seismic receivers adapted to measure a plurality of particle motion vector components including two horizontal components;

(b) selecting the two horizontal components of the seismic data for each receiver, and determining survey azimuth angles for all selected data based on source and receiver locations;

(c) selecting only a part of said two horizontal components, the selected part corresponding to survey azimuths that are either parallel or perpendicular to fracture planes in the subsurface formation based on, for example, (i) a priori knowledge of the fracture orientation, or on (ii) azimuth-offset scanning of said horizontal components, where offset is source-receiver separation, or on (iii) selecting seismic data only from a small offset range determined based on a model study or other estimate of particle displacement dependence on offset and survey azimuth; and then discarding all of the two horizontal components that was not selected here in (c); and

(d) performing layer stripping on said selected seismic data corresponding to parallel and perpendicular survey azimuths, and generating fracture orientations and S-wave time differences for the subsurface formation.

In another embodiment, the invention is a computer-implemented method for transforming multi-component seismic data including two horizontal components into a prediction of lithology within a multi-fractured subsurface formation having a plurality of parallel fracture layers, comprising:

rotating the two horizontal components of the seismic data into radial and transverse components and then dividing into bins according to survey azimuth and common reflection point;

obtaining estimates of fracture orientation and S-wave time difference as a function of (x,y) location by processing the radial and transverse components or by any other method or from any source;

rotating each bin of radial and transverse components to a faster S-wave mode and a slower S-wave mode using said generated fracture orientations;

shifting the slower S-wave mode in time by said estimated S-wave time differences, resulting in true-amplitude fast and slow S-waves; and

using the true-amplitude fast and slow S-waves to predict lithology of the subsurface formation.

### BRIEF DESCRIPTION OF THE DRAWINGS

Due to patent law restrictions, one or more of the drawings are black-and-white reproductions of color originals. The color originals have been filed in the counterpart U.S. application. Copies of this patent or patent application publication with the color drawings may be obtained from the US Patent and Trademark Office upon request and payment of the necessary fee.

The present invention and its advantages will be better understood by referring to the following detailed description and the attached drawings in which:

FIGS. 1A and 1B show particle displacement polarization of fast (FIG. 1A) and slow (FIG. 1B) modes in an HTI medium (one set of vertical fracture in an isotropic background);

FIGS. 2A and 2B show particle displacement polarization of fast (FIG. 2A) and slow (FIG. 2B) modes in an orthorhombic medium (one set of vertical fracture in a VTI background);

FIG. 3 is a flowchart showing basic steps in one embodiment of the present inventive method;

FIGS. 4A and 4B show estimated fracture orientations (FIG. 4A) and S-wave time-difference (FIG. 4B) maps generated using the present inventive method;

FIG. 5 is a flowchart showing basic steps in an aspect of the present invented method whereby true-amplitude PS₁ and PS₂ may be generated from the recorded converted-wave data;

FIGS. 6A and 6B show synthetic radial (6A) and transverse (6B) PS data components;

FIGS. 7A and 7B show PS₁ (FIG. 7A) and PS₂ (FIG. 7B) derived from the radial and transverse components of FIGS. 6A-6B using the present inventive method as outlined in FIG. 5; and

FIGS. 8A-8F are displays of estimated fracture orientations (8A, 8C and 8E) and S-wave time difference (8B, 8D and 8F) maps from different azimuths.

The originals of the following figures were in color: 1A-2B, 2A-2B, 4A-4B and 8A-8F. Due to patent law restrictions in a particular country, those drawings may be shown herein as black-and-white reproductions of the original color drawings.

The invention will be described in connection with example embodiments. However, to the extent that the following detailed description is specific to a particular embodiment or a particular use of the invention, this is intended to be illustrative only, and is not to be construed as limiting the scope of the invention. On the contrary, it is intended to cover all alternatives, modifications and equivalents that may be included within the scope of the invention, as defined by the appended claims. Persons skilled in the technical field will readily recognize that in practical applications of the present inventive method, it must be performed on a computer, typically a suitably programmed digital computer.

### DETAILED DESCRIPTION OF EXAMPLE EMBODIMENTS

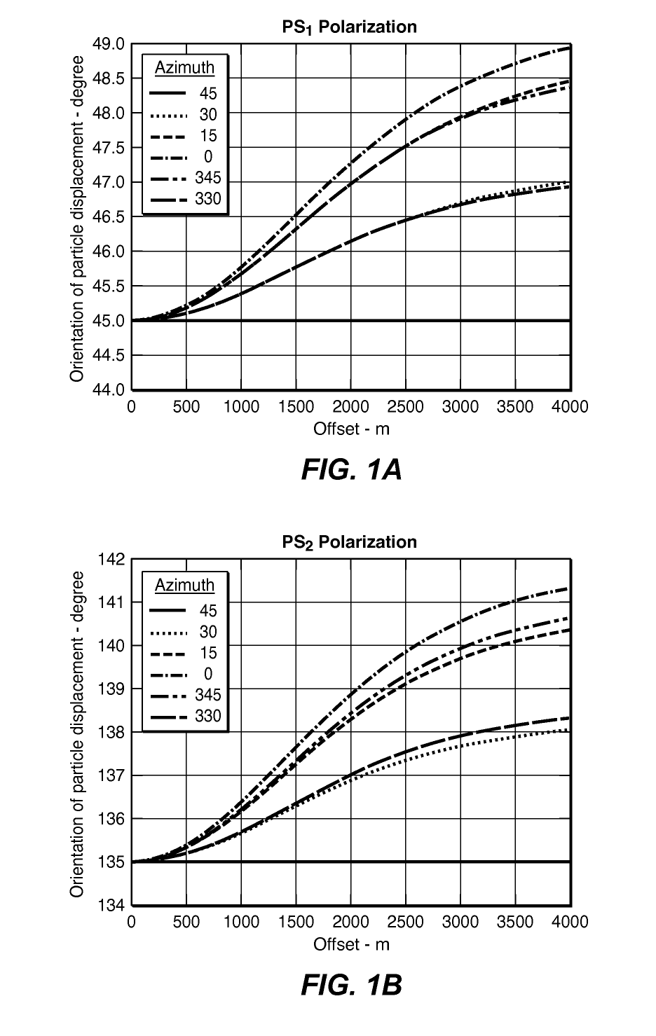

To understand the behavior of S-wave particle polarization, the present inventors performed synthetic seismic modeling and calculated particle polarizations of fast (S₁) and slow (S₂) waves. FIGS. 1A and 1B show particle polarization of the reflected fast (PS₁) and slow (PS₂) modes, respectively, from the base of a vertically fractured layer, i.e. an HTI medium as exemplified by one set of vertical fractures in an isotropic background. Particle polarizations are displayed for several offsets (ranging from 10 m to 4000 m) and survey azimuths (each curve corresponds to a different azimuth, as specified in the key). The fractures strike in the medium is 45° N clockwise and the crack density is 7%. (The terms fracture strike, fracture azimuth, fracture orientation, and fracture direction, may be used interchangeably herein.) At near offsets, the particle displacements of PS₁-mode are polarized parallel to the fractures(45°) and the particle displacements of PS₂-mode are polarized perpendicular (135°) to the fractures. This is true for all azimuths. At mid and far offsets, PS₁ and PS₂ for most of those same azimuths are no longer polarized parallel and perpendicular to the fractures. When the survey azimuth is in the fracture strike and normal directions, however, PS₁- and PS₂-modes are polarized parallel and perpendicular to the fractures, respectively, at all offsets.

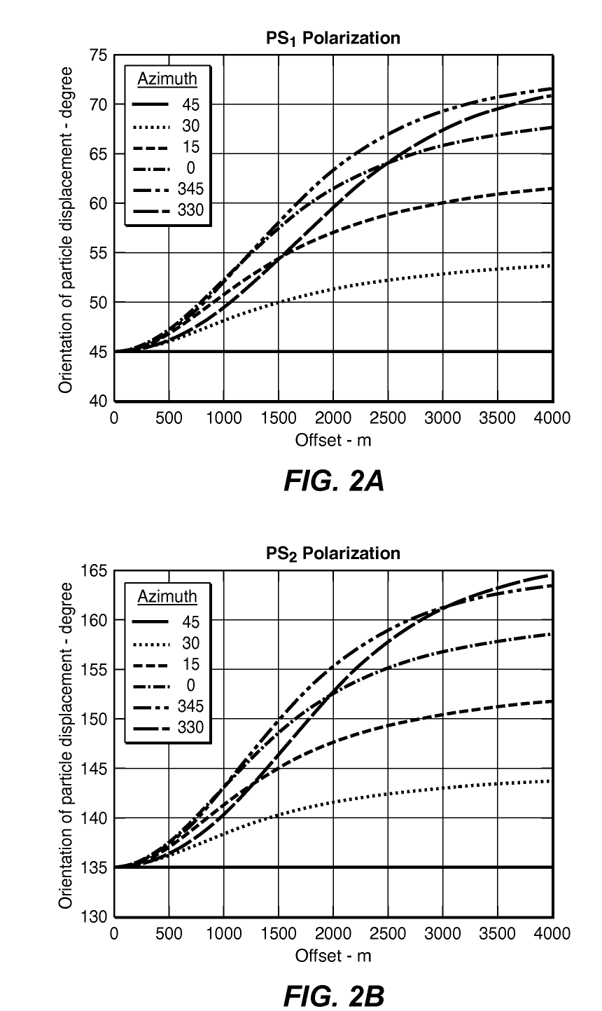

FIGS. 2A and 2B show particle polarization of PS₁ and PS₂ modes, respectively, from the base of an orthorhombic medium. The orthorhombic medium was generated by embedding one set of vertical fractures in a VTI medium of moderate anisotropy. The fractures have a strike of 45° N clockwise with a crack density of 7%. The results are qualitatively the same as the HTI medium results in FIGS. 1A and 1B, only more pronounced. At near offsets, the particle displacements of PS₁-mode are polarized parallel to the fractures (45°) and the particle displacements of PS₂-mode are polarized perpendicular to the fractures (135°). At mid and far offsets, PS₁ and PS₂ are no longer polarized parallel and perpendicular to the fractures. When the survey azimuth is in the fracture strike and normal directions, however, PS₁- and PS₂-modes are polarized parallel and perpendicular to fracture, respectively, at all offsets. Note that in an orthorhombic medium, particle displacement deviation from fracture strike and normal is much more profound than in the equivalent HTI medium (compare FIGS. 1A-1B and 2A-2B). Thus, it may be expected that the existing fracture characterization methods [8, 9] will perform more poorly in an orthorhombic medium than in an HTI medium.

FIGS. 1A-1B and 2A-2B were generated to test the theory that became the basis for the present invention, as will be seen from the description of the invention that follows. These drawings suggest that fracture parameters determined by layer stripping will be more accurate if data corresponding to certain combinations of survey azimuth and offset are used with the rest being discarded. In other words, the invention in one of its embodiments is a method for determining what part of the horizontal-component seismic data represents particle displacement of split S-waves propagating through a fractured medium that are polarized either parallel or perpendicular to the fractures strike, so that the remainder of the data can be discarded. Small offsets may be expected to give good results for all azimuths, with the longer offset data being discarded. Alternatively, data (at all offsets) corresponding to survey azimuths either parallel or perpendicular to the fractures should be selected, with data corresponding to other azimuths being discarded. In this latter embodiment of the invention, the general fracture trend may sometimes be known, but often is not. For cases where the fracture orientation is not known, the invention provides an azimuth-offset scanning process by which the preferred data may be identified and the rest discarded.

The present invention is a method for generating fracture parameters (fracture orientation and time difference between PS₁ and PS₂ modes). The method also produces true-amplitude PS₁ and PS₁ modes, which can be used for reservoir property prediction in the subsurface. The time difference between PS₁ and PS₁ can be indicator of fracture intensity; the larger this time difference, the larger the fracture intensity. This time difference may be called S-wave time difference in this document.

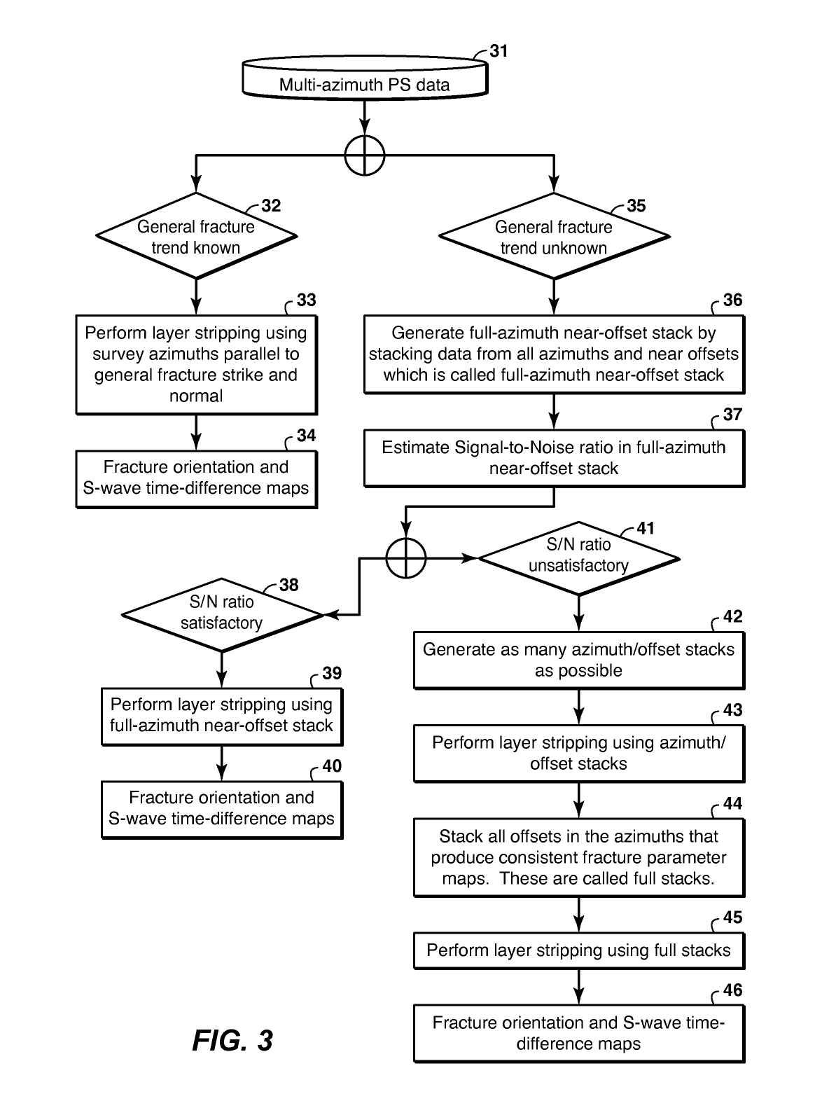

The flowchart of FIG. 3 will be referred to in describing the invention. The invention first requires acquisition of multi-component, multi-azimuth data (31). Azimuth is defined for a particular source-receiver combination. The direction (relative to true North or some other reference direction) of the line connecting a source-receiver pair is called the azimuth of that particular source-receiver pair and associated seismic data. Traditionally, only the vertical component of the seismic wavefield, which is dominated by the P-wave energy, is acquired. For certain applications, all three vector components of the wavefield are also acquired (using a motion-detector type of seismic receiver). In this type of acquisition, a P-wave source (either dynamite or a vertical vibrator) is used. The vertical component of the data mostly contains P-wave energy and the two horizontal components carry converted-wave PS energy. The PS energy is defined as P-wave energy reflected back from a reflector as S-wave energy; i.e., P-wave energy travels down, and some of that energy is reflected back up in an S-wave mode. The acquired PS energy may be rotated into radial and transverse components. Free-surface related seismic noise such as surface-waves and free-surface multiples may be removed from the radial and transverse components. After noise correction, normal moveout (NMO) correction may be applied on the data to flatten the reflections. Another way to flatten the reflections is by pre-stack time migration. These are standard processing steps and are routinely applied in seismic data processing. The data coming out of this step are called flattened gathers. The flattened gathers at all azimuths are stacked into near-, mid- and far-offset stacks. Another stack may be generated by combining the entire near-offset stacks from all azimuths. This stack is called a full-azimuth, near-offset stack (36).

The present inventive method uses layer-stripping in conjunction with appropriate azimuth-offset selection/scanning. This process finds the right offset and azimuths to perform layer-stripping which eventually yields fracture parameters for each fractured layer. A number of methods have been published on layer stripping from surface seismic data. To name a few, Gaiser [9, 14] published a method called “3-D converted shear wave rotation with layer stripping”. Another method was published by Thomsen et al., [11] called “coarse layer stripping of vertically variable azimuthal anisotropy from shear-wave data”. Granger et al., [12] developed a method to find the fast S-wave direction which corresponds to the fracture orientation. Haacke et al. [17] proposed a method of layer-stripping in marine data. Crampin [13] gave a detailed description of S-wave propagation in fractured media which led to development of the layer-stripping technique.

All layer-stripping techniques mentioned above are based on the birefringence property of S-waves in the fracture media described above. In one out of many possible embodiments of the present invention, the method proposed by Gaiser [9, 14] is used. In this particular approach, orthogonal survey azimuths are combined to perform layer stripping. In another possible embodiment, using the method as proposed in Granger et al. [12], the ratio of the radial and transverse components is analyzed to perform layer stripping. It must be noted that the present inventive method is not dependent on the type of layer stripping method used.

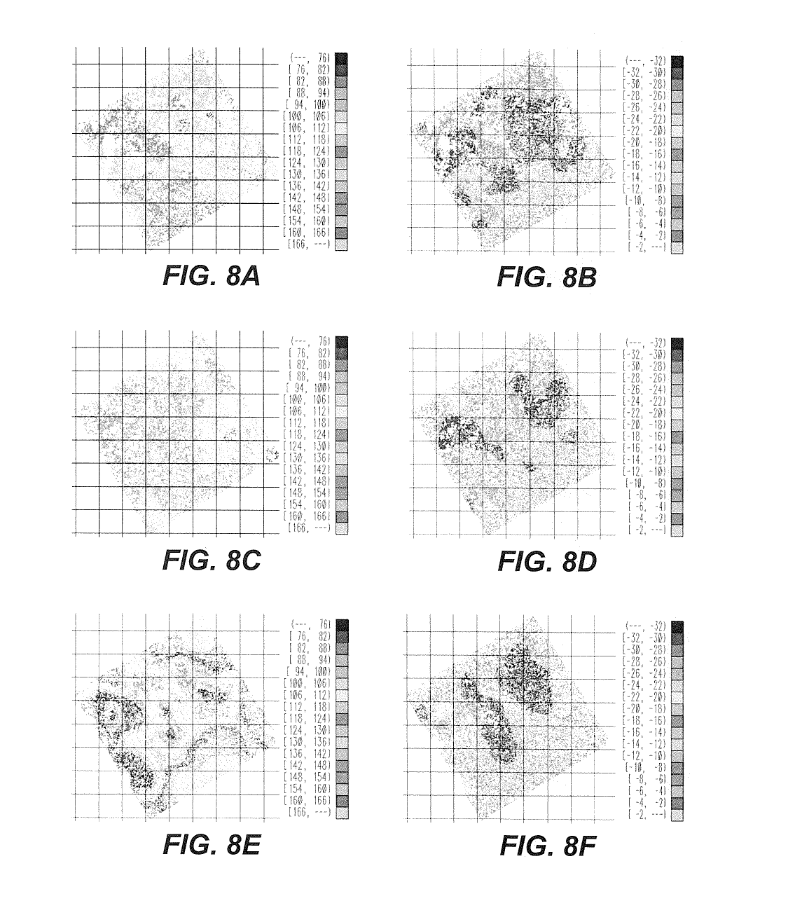

FIG. 3 shows three alternative approaches, each producing (34, 40 and 46) fracture directions and time differences. If the general fracture orientation in the area is known (32), the data from the azimuths parallel to the general fracture orientation may be used (33) to estimate fracture directions and time differences (34) by layer stripping. If the general fracture orientation is not known (35), a full-azimuth near-offset stack may be produced by stacking near-offset data from all azimuths (36). The signal-to-noise ratio in the full-azimuth near-offset stack maybe estimated at step 37, and if it is acceptable (38), it may be used to perform layer-stripping to produce fracture orientation and time-difference maps (40). If the general fracture orientation is not known and the signal-to-noise ratio in the full-azimuth near-offset stack is not satisfactory enough for layer-stripping (41), the data (referring now to all the data, 31, not just the near-offset data) may be divided into a number of azimuth sectors and offset stacks, preferably as many azimuths/offsets as possible (42). This division depends on the signal-to-noise ratio in the data. If the number of azimuth/offset stacks is too large, the amount of data in each stack will become so small that cancellation of random noise, which is a main reason for stacking, will be incomplete, and the signal-to-noise ratio will be inferior. The azimuth/offset stacks are used to perform layer stripping (43) and generate a fracture direction and S-wave time-difference maps. Each offset-azimuth pair will generate such maps. The maps are next scanned for consistency in values. In most of the fracture parameter maps, there will be inconsistency. For certain azimuths and offsets, however, both fracture orientation and time-difference maps will typically be consistent. In other words, these particular azimuths/offsets stacks will produce the same values, within a selected tolerance, for fracture direction and S-wave time difference out of layer stripping. FIGS. 8A-8F show estimated fracture orientations (8A, 8C and 8E) and S-wave time difference (8B, 8D and 8F) maps from different azimuths. Fracture directions in (8A) and (8C) match in character but the fracture directions in (8E) do match with those in (8A) and (8C). In this example, there is good consistency in the fracture-orientation maps but not so much in the time-difference maps. Consistency for both fracture parameters is preferable, but the invention may be applied using consistency for a single fracture parameter.

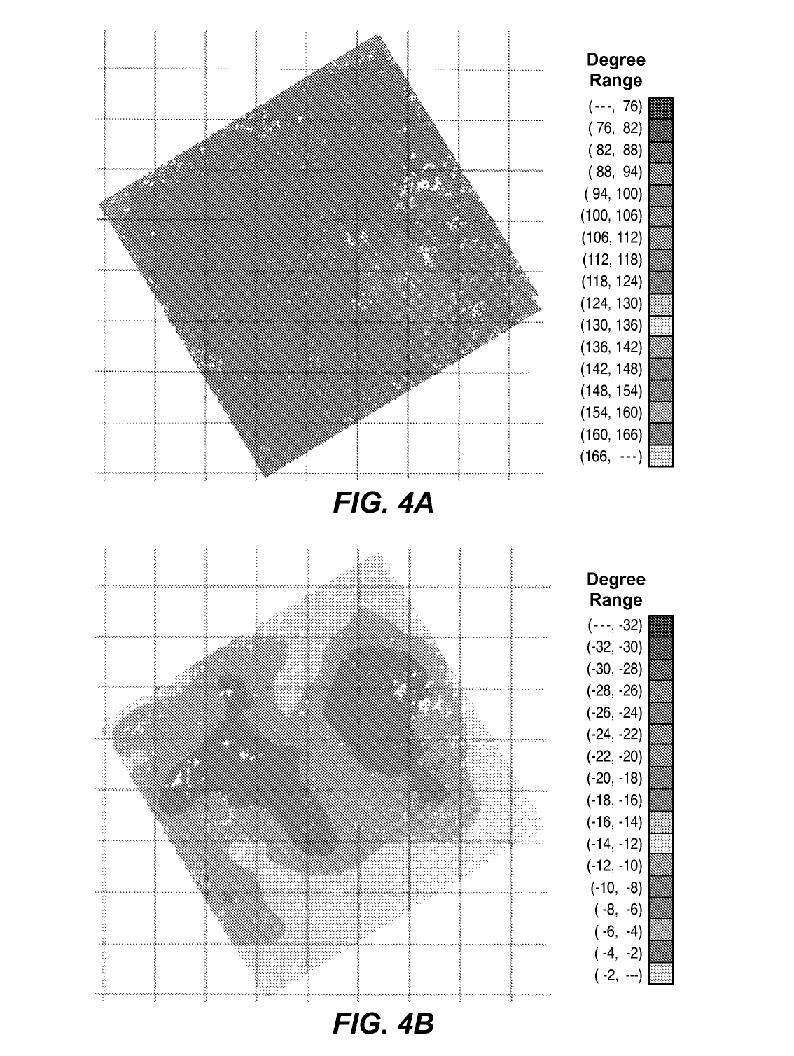

Once the azimuth-offset pairs that produce consistent results have been identified by the scanning process of step 44, stack all the offsets from the azimuths that produce consistent results, and discard the rest. These stacks are called full-stack in a particular azimuth. This process improves the signal-to-noise ratio in the data. Alternatively, the choice of which azimuth/offset stacks should be discarded may be made by taking an average of the fracture azimuths yielded by each offset-azimuth pair, and using agreement with the average as the basis for whether to keep or discard the corresponding data, with good agreement meaning the data should be kept and poor agreement meaning the data should be discarded. This is a different type of scanning from that described just above where the azimuth/offset scanning may be thought of as being over all offsets for each azimuth. Layer-stripping may then be performed using the full stacks (45) to generate at step 46 final fracture parameter maps (fracture direction and S-wave time difference). FIGS. 4A and 4B show an example of fracture orientation (FIG. 4A) and S-wave time difference (FIG. 4B) maps generated by the present inventive method. FIG. 4A shows the fracture orientation (in degrees) from North and FIG. 4B shows the time difference between slow and fast S-waves in milliseconds.

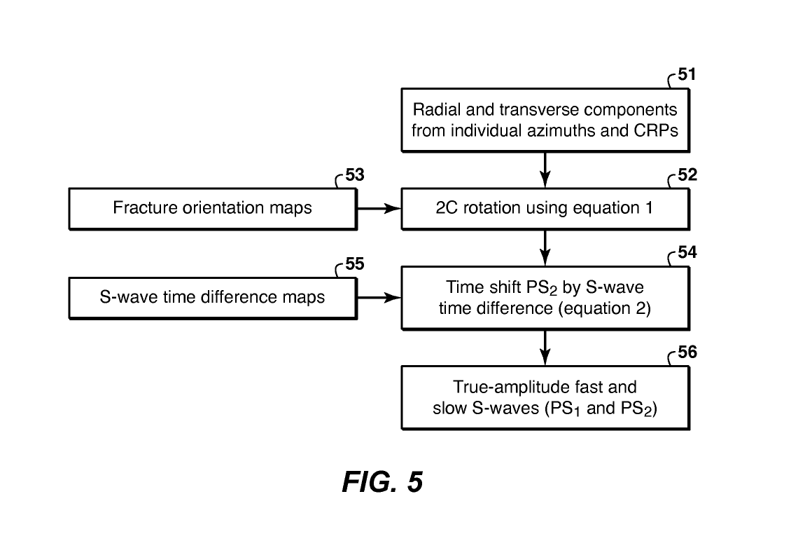

In another aspect of the present invention, fast (PS₁) and slow (PS₂) converted-waves may be generated using the fracture parameters produced either by the present inventive method, e.g. FIG. 3, or by any other method. As mentioned before, the horizontal component of the recorded energy is dominated by the PS converted-waves. These horizontal components may be rotated to radial and transverse components for the processing. In the absence of fracturing (or azimuthal anisotropy), all the converted-wave energy is only found on the radial components and the transverse component has little or no converted-wave energy. In the presence of fracturing, however, transverse components may have a significant amount of the converted-wave energy. As mentioned before, in the fractured media, S-waves split into fast and slow S-waves, designated by S₁ and S₂ respectively. However, the downgoing P-wave does not split into fast and slow modes. Hence the reflected converted waves are defined as PS₁ and PS₂. The recorded radial and transverse components have mixed phases of PS₁ and PS₂ modes. To understand and to invert for the lithological properties of the subsurface, it is important to separate out these mixed modes from the radial and transverse components because the lithology responses are controlled by PS₁ and PS₂ modes and not by the radial and transverse components. PS₁ and PS₂ modes may be derived out of the radial and transverse components in the following steps, with reference to the flowchart of FIG. 5.

At step 51, the radial and transverse components are binned in separate azimuths and common reflection points (CRPs). For the converted waves, CRPs can be ACP or CCP locations (CCP stands for common conversion point which is similar to CRP; ACP stands for asymptotic conversion point which is an approximated version of CCP). The reader may refer to Thomsen [17] for further discussion on this topic. At step 52, the binned radial and transverse gathers are rotated to PS₁ and PS₂ using the following formula:

$$[ \begin{matrix}{PS}_{1}^{AZ , C} \\ {PS}_{2}^{AZ , C}\end{matrix} ] = [ \begin{matrix}cos ( {θ}^{C} - ϕ ) & sin ( {θ}^{C} - ϕ ) \\ - sin ( {θ}^{C} - ϕ ) & cos ( {θ}^{C} - ϕ )\end{matrix} ] [ \begin{matrix}{PS}_{R}^{AZ , C} \\ {PS}_{T}^{AZ , C}\end{matrix} ] , \qquad ( 1 )$$

where φ is survey azimuth and θ is fracture orientation in a layer. Here AZ stands for the azimuth and C stands for CRP. The fracture orientation map (53), which provides the value of θ^{C} for each fractured layer corresponding to a CRP, may be derived from an embodiment of the present inventive method such as one of the embodiments outlined in FIG. 3. This process may be called 2C rotation. Next, in step 54, PS₂, the slower of the two modes, is shifted in time by the time difference estimated previously (55), for example by one of the embodiments of the present invention outlined in FIG. 3. The following formula may be used:

PS_{2,shifted}^{AZ,C}(t)=PS₂^{AZ,C}(t−Δt^{C}), (2)

where Δt^{C} is the time difference at the location C. Then, steps 52 and 54 may be repeated for subsequent fracture layers C.

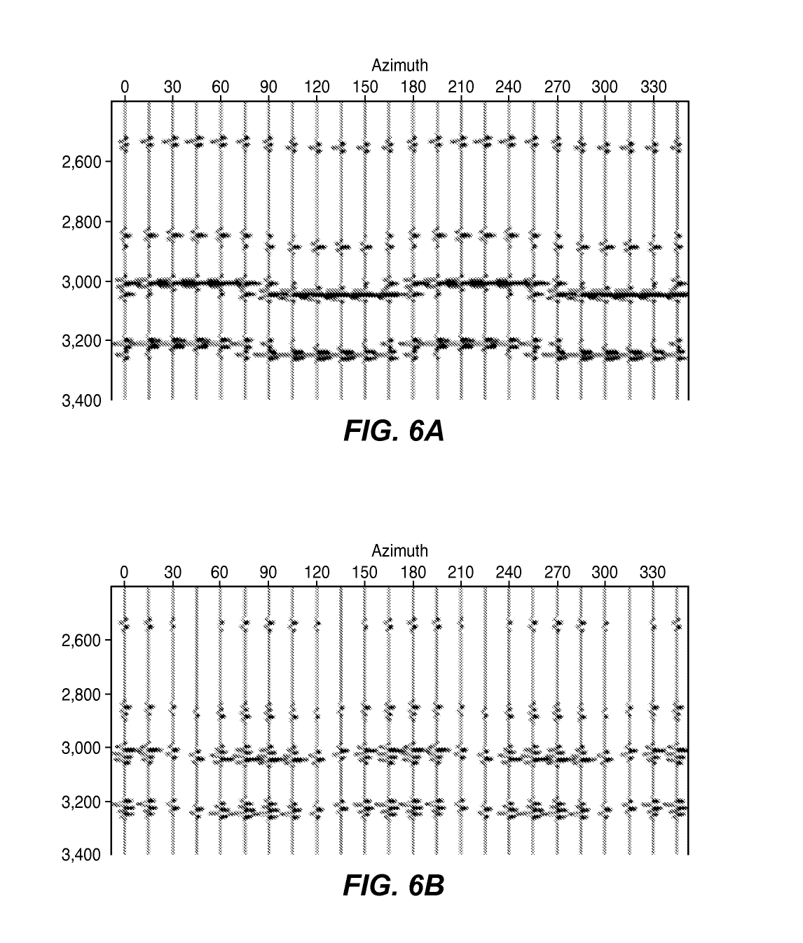

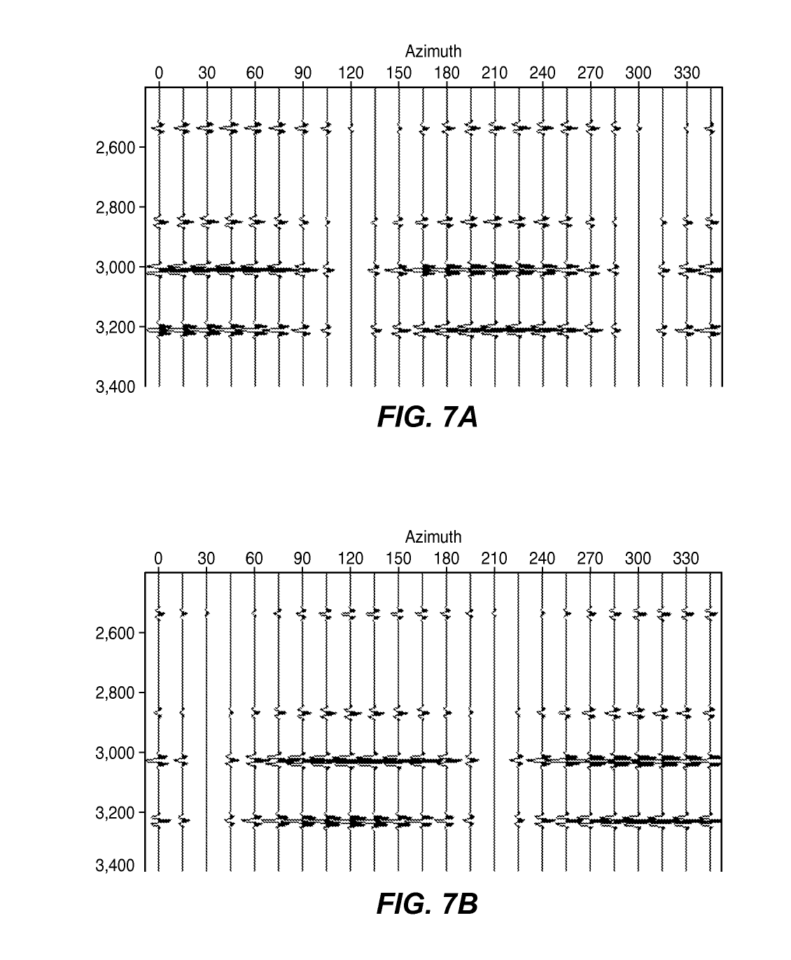

The foregoing process will generate true-amplitude PS₁ and PS₂ modes (56), which can be used for reservoir property prediction. FIGS. 6A and 6B show a synthetic example of radial (FIG. 6A) and transverse (FIG. 6B) components at all azimuths. FIGS. 7A and 7B show the derived PS₁ (FIG. 7A) and PS₂ (FIG. 7B) at all azimuths out of the radial and transverse components using the method of FIG. 5.

The foregoing patent application is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined in the appended claims.

### REFERENCES

1. Aguilera, R., Naturally fractured reservoirs, PennWell Book, Tulsa (1995).
2. Nelson, R. A., Geologic analysis of naturally fractured reservoirs, Gulf Publishing Company, Houston (2001).
3. Sinha, B. K., Norris, A. N. and Chang, S., “Borehole flexural modes in anisotropic formations,” Geophysics 59, 1037-1052 (1994)
4. Schoenberg, M. and Douma, J., “Elastic wave propagation in media with parallel fractures and aligned cracks,” Geophysical Prospecting 36, 571-590 (1988).
5. Ruger, A. and Tsvankin, I., “Using AVO for fracture detection: Analytic basis and practical solutions,” The Leading Edge 16, 1429 (1997).
6. MacBeth, C. and Crampin, S., “Comparison of signal processing techniques for estimating the effects of anisotropy,” Geophysical Prospecting 39, 357-386 (1991).
7. Alford, R. M., “Multisource multireceiver method and system for geophysical exploration,” U.S. Pat. No. 5,343,441 (1994).
8. Winterstein, D. F. and Meadows, M. A., “Shear-wave polarization and subsurface stress directions at Lost Hills field,” Geophysics 56, 1331-1348 (1991).
9. Gaiser, J. E., “3-D converted shear wave rotation with layer stripping,” U.S. Pat. No. 5,610,875 (1997).
10. Tsvankin, I., Seismic signatures and analysis of reflection data in anisotropic media, Pergamon, New York, see particularly the last paragraph of page 11, (2001).
11. Thomsen, L., Tsvankin, I. and Mueller, M. C., “Coarse-layer stripping of vertically variable azimuthal anisotropy from shear-wave data,” Geophysics 64, 1126-1138 (1999).
12. Granger, P. Y., Bonnot, J. M., Gresillaud, A. and Rollet, A., “C-wave resolution enhancement through birefringence compensation at the Valhall field,” Society of Exploration Geophysicist Annual Conference (2001).
13. Crampin, S., “Evaluation of anisotropy by shear-wave splitting,” Geophysics 50, 142-152 (1985).
14. Gaiser, J. E., “Application for vector coordinate systems of 3-D converted-wave data,” The Leading Edge 18, 1290-1300 (1999).
15. Alford, R. M., “Shear data in the presence of azimuthal anisotropy: Dilley, Tex.,” SEG Expanded Abstracts 5, 476-479 (1986).
16. Thomsen, L., “Converted-wave reflection seismology over inhomogeneous media,” Geophysics 64, 678-690 (1999).
17. Haacke, R. R., Westbrook, G. K. and Peacock, S., “Layer stripping of shear-wave splitting in marine PS waves,” Geophysical Journal International 176, 782-804 (2009).

1. A computer-implemented method for transforming seismic data into an estimate of fracture orientations and intensity, or of lithology, within a multi-fractured subsurface formation having a plurality of parallel fracture layers, comprising:
(a) obtaining seismic data acquired from the subsurface formation using multi-component seismic receivers adapted to measure a plurality of particle motion vector components including two horizontal components;
(b) selecting the two horizontal components of the seismic data for each receiver, and determining survey azimuth angles for all selected data based on source and receiver locations;
(c) selecting a part but not all of the two horizontal components, said selected part being seismic data corresponding to survey azimuths that are either parallel or perpendicular to fracture planes in the subsurface formation, and discarding all of the two horizontal components not in said selected part; and
(d) using a computer to perform layer stripping on the selected part of the two horizontal components, and generating fracture orientations and S-wave time differences for the subsurface formation.

2. The method of claim 1, wherein selection of seismic data corresponding to survey azimuths that are either parallel or perpendicular to fracture planes in the subsurface formation is based on (i) a priori knowledge of the fracture orientation, or on (ii) azimuth-offset scanning of said horizontal components, where offset is source-receiver separation, or on (iii) selecting seismic data only from a small offset range determined based on a model study or other estimate of particle displacement dependence on offset and survey azimuth.

3. The method of claim 2, wherein the selection of seismic data is based on (iii), and further comprising generating full-azimuth, near-offset stacks by stacking data from all azimuths and the determined small offsets, wherein the layer stripping is performed on these full-azimuth, near-offset stacks.

4. The method of claim 2, wherein azimuth-offset scanning is used and it comprises:
dividing the selected two horizontal components of the seismic data into a plurality of stacks specified by azimuth and offset (“azimuth/offset stacks”);
performing layer stripping on the azimuth/offset stacks and generating fracture orientations and S-wave time differences for each azimuth/offset stack;
selecting azimuth/offset stacks based on consistency in their prediction of fracture orientations and S-wave time differences and discarding inconsistent azimuth/offset stacks;
stacking all offsets for each azimuth in the selected azimuth/offset stacks, thereby forming “full stacks;” and
performing the layer stripping in (d) on the full stacks.

5. The method of claim 4, wherein maps of fracture orientation and time difference between fast and slow converted wave modes are produced for each azimuth/offset stack, and consistency is judged by comparing the maps.

6. The method of claim 4, wherein the consistency is judged by computing an average of the fracture orientations predicted by each azimuth/offset stack, and defining consistency based on closeness to the average.

7. The method of claim 4, wherein said plurality of azimuth/offset stacks is limited in number by signal-to-noise ratio of each stack.

8. The method of claim 1, wherein selecting the two horizontal components of the seismic data for each receiver, and determining corresponding azimuth angles for each component based on source and receiver locations comprises rotating converted-wave data into radial and transverse components using survey acquisition geometry.

9. The method of claim 8, further comprising estimating true-amplitude fast and slow S-waves by steps comprising:
binning said radial and transverse components into gathers according to azimuth and common reflection point;
rotating the binned radial and transverse gathers to a faster and a slower S-wave mode using said generated fracture orientations;
shifting the slower S-wave mode in time by said generated S-wave time differences.

10. The method of claim 9, further comprising using the estimated true-amplitude fast and slow S-waves for lithology estimates of the subsurface formation.

11. The method of claim 9, wherein the rotating of the binned radial and transverse gathers uses a formula that can be expressed as
$$[ \begin{matrix}{PS}_{1}^{AZ , C} \\ {PS}_{2}^{AZ , C}\end{matrix} ] = [ \begin{matrix}cos ( {θ}^{C} - ϕ ) & sin ( {θ}^{C} - ϕ ) \\ - sin ( {θ}^{C} - ϕ ) & cos ( {θ}^{C} - ϕ )\end{matrix} ] [ \begin{matrix}{PS}_{R}^{AZ , C} \\ {PS}_{T}^{AZ , C}\end{matrix} ]$$
where PS₁ and PS₂ are the faster and a slower S-wave modes, respectively, where φ is survey azimuth and θ is fracture orientation in a layer, AZ stands for azimuth and C stands for common reflection point.

12. The method of claim 11, wherein the shifting the slower S-wave mode in time uses a formula that can be expressed as
PS_{2,shifted}^{AZ,C}(t)=PS₂^{AZ,C}(t−Δt^{C}),
where Δt^{C} is the time difference at location C.

13. The method of claim 1, further comprising estimating fracture intensity from the S-wave time differences.

14. A method for producing hydrocarbons from a multi-fractured subsurface formation having a plurality of parallel fracture layers, comprising:
obtaining seismic data from a multi-component seismic survey of the subsurface formation;
processing the seismic data using a method of claim 1 to generate fracture parameters for the subsurface formation;
drilling a well into the subsurface formation based at least in part on said fracture parameters, and producing hydrocarbons from the well.

15. A computer-implemented method for transforming multi-component seismic data including two horizontal components into a prediction of lithology within a multi-fractured subsurface formation having a plurality of parallel fracture layers, comprising:
(a) rotating the two horizontal components of the seismic data into radial and transverse components and then dividing into bins according to survey azimuth and common reflection point;
(b) obtaining estimates of fracture orientation and S-wave time difference as a function of (x,y) location by processing the radial and transverse components or by any other method or from any source;
(c) rotating each bin of radial and transverse components to a faster S-wave mode and a slower S-wave mode using said generated fracture orientations;
(d) shifting the slower S-wave mode in time by said estimated S-wave time differences, resulting in true-amplitude fast and slow S-waves; and
(e) using the true-amplitude fast and slow S-waves to predict lithology of the subsurface formation;
wherein at least one of (a)-(d) is performed using a computer

16. The method of claim 15, wherein the rotating of each bin of radial and transverse components uses a formula that can be expressed as
$$[ \begin{matrix}{PS}_{1}^{AZ , C} \\ {PS}_{2}^{AZ , C}\end{matrix} ] = [ \begin{matrix}cos ( {θ}^{C} - ϕ ) & sin ( {θ}^{C} - ϕ ) \\ - sin ( {θ}^{C} - ϕ ) & cos ( {θ}^{C} - ϕ )\end{matrix} ] [ \begin{matrix}{PS}_{R}^{AZ , C} \\ {PS}_{T}^{AZ , C}\end{matrix} ]$$
where PS₁ and PS₂ are the faster and a slower S-wave modes, respectively, where φ is survey azimuth and θ is fracture orientation in a layer, AZ stands for azimuth and C stands for common reflection point.

17. The method of claim 16, wherein the shifting the slower S-wave mode in time uses a formula that can be expressed as
PS_{2,shifted}^{AZ,C}(t)=PS₂^{AZ,C}(t−Δt^{C}),
where Δt^{C} is the time difference at location C.
